(19) United States
(12) Patent Application Publication
(10) Pub. No.: US 2026/0129533 A1
(43) Pub. Date: May 7, 2026

(54) DOWNLINK-COVERAGE ENHANCEMENTS CAPABILITY-BASED CELL RESELECTION IN WIRELESS SYSTEMS

(71) Applicant: InterDigital Patent Holdings, Inc., Wilmington, DE (US)

(72) Inventors: Keiichi Kubota, Tokyo (JP); Brian Martin, Farnham (GB); Umer Salim, Vallauris (FR)

(73) Assignee: InterDigital Patent Holdings, Inc., Wilmington, DE (US)

(21) Appl. No.: 18/936,595

(22) Filed: Nov. 4, 2024

(51) Int. Cl. H04W 36/08; H04W 36/00; H04W 84/06

(52) U.S. Cl. CPC H04W 36/08; H04W 36/0061; H04W 36/008357; H04W 84/06

(57) ABSTRACT

Systems, methods, devices, and instrumentalities are described herein for downlink-coverage enhancements (DL-CE) capability-based cell selection or cell reselection. A wireless transmit/receive unit (WTRU) may receive system information including absolute priority information associated with non-terrestrial network (NTN) and downlink-coverage enhancements (DL-CE) capabilities. In examples, the WTRU may determine to use the absolute priority information for the WTRU based on the absolute priority information being associated with the NTN and DL-CE capabilities if the WTRU supports those capabilities. The absolute priority information may include a first absolute priority value associated with a first frequency and a second absolute priority value associated with a second frequency. Reselection may be performed by prioritizing a cell associated with the second frequency based on the determination that the second absolute priority value associated with the second frequency is greater than the first absolute priority value associated with the first frequency.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, devices, and instrumentalities are described herein for downlink-coverage enhancements (DL-CE) capability-based cell selection.

A wireless transmit/receive unit (WTRU) may receive system information. The WTRU may support non-terrestrial network (NTN) and DL-CE capabilities. The system information may be received in a system information block (SIB). The system information may include first absolute priority information associated with NTN and DL-CE capabilities, and second absolute priority information not associated with NTN and DL-CE capabilities. The system information may (e.g., may further) include assistance information associated with the cell. In examples, the WTRU may determine to use the first absolute priority information for the WTRU based on the first absolute priority information being associated with the NTN and DL-CE capabilities. In examples, the WTRU may determine to use the first absolute priority information for the WTRU based on (e.g., further based) on the assistance information.

The assistance information may include at least one of: a state transition pattern, a synchronization signal block (SSB) periodicity, or a duty cycle associated with the state transition pattern. In examples, the state transition pattern may include a completely off state and an on state. In examples, the state transition pattern may include a completely off state, a common channel only state, and an on state. In examples, the assistance information (e.g., state transition pattern) may include information to determine a state of the cell.

The first absolute priority information may include a first absolute priority value associated with a first frequency and a second absolute priority value associated with a second frequency. Reselection may be performed using the first absolute priority information for the WTRU. The reselection using the first absolute priority information for the WTRU may be performed by determining that the second absolute priority value associated with the second frequency is greater than the first absolute priority value associated with the first frequency. Based on the determination that the second absolute priority value associated with the second frequency is greater than the first absolute priority value associated with the first frequency, the second frequency may be prioritized. Reselection may be performed to a cell associated with the second frequency. Uplink information may be transmitted to the cell. The cell may be a neighbor cell. The reselection to the neighbor cell may be a reselection from a serving cell to the neighbor cell. The neighbor cell may have NTN and DL-CE capabilities.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of downlink-coverage enhancements (DL-CE) capabilities-based cell selection or cell reselection.

### DETAILED DESCRIPTION

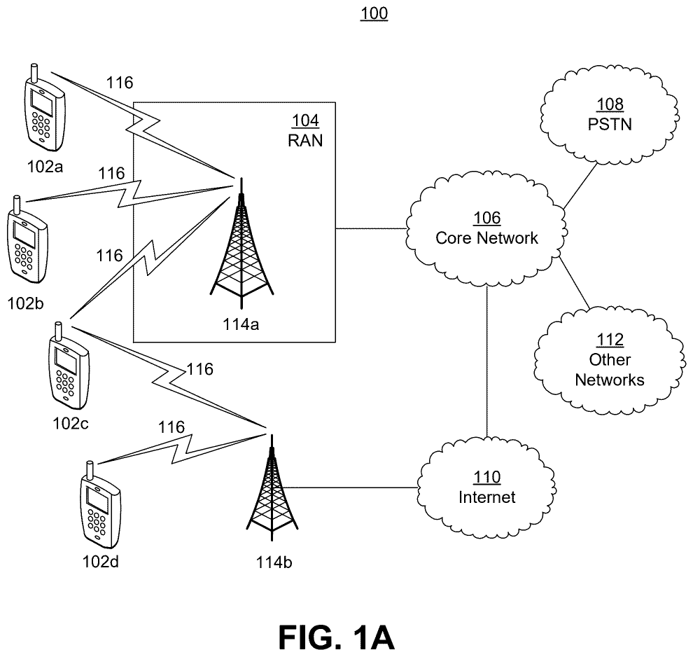

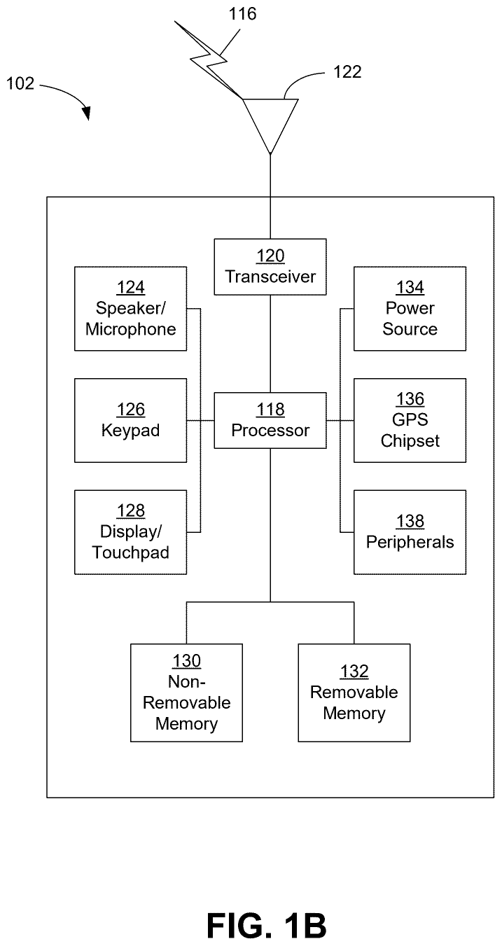

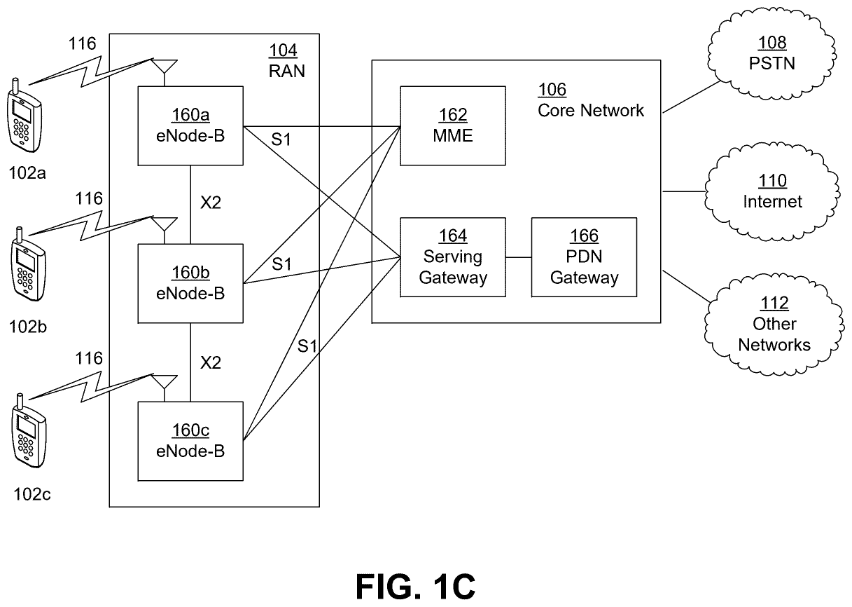

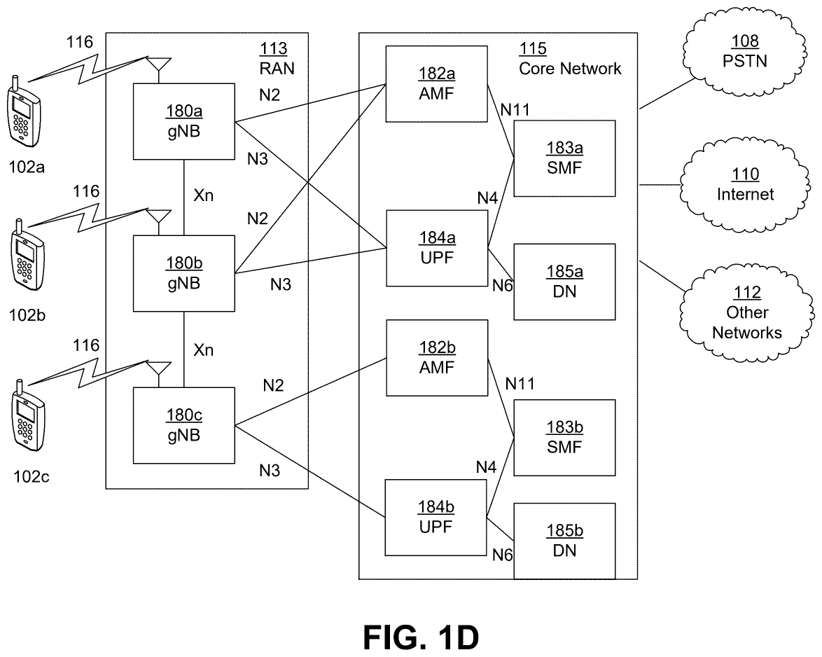

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), a Distributed Unit (DU), a Centralized Unit (CU), a gNB, relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three or more sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the uplink (UL) (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Reference to a timer herein may refer to determination of a time or determination of a period of time. Reference to a timer expiration herein may refer to determining that the time has occurred or that the period of time has expired. Reference to a timer herein may refer to a time, a time period, tracking the time, tracking the period of time, etc.

Systems, methods, devices, and instrumentalities are described herein for downlink-coverage enhancements (DL-CE) capability-based cell selection and cell reselection. A wireless transmit/receive unit (WTRU) may receive system information. The WTRU may support non-terrestrial network (NTN) and DL-CE capabilities. The system information may be received in a system information block (SIB). The system information may include first absolute priority information associated with NTN and DL-CE capabilities, and second absolute priority information not associated with NTN and DL-CE capabilities. The system information may (e.g., may further) include assistance information associated with the cell. In examples, the WTRU may determine to use the first absolute priority information for the WTRU based on the first absolute priority information being associated with the NTN and DL-CE capabilities. In examples, the WTRU may determine to use the first absolute priority information for the WTRU based on (e.g., further based) on the assistance information.

The assistance information may include at least one of: a state transition pattern, a synchronization signal block (SSB) periodicity, or a duty cycle associated with the state transition pattern. In examples, the state transition pattern may include a completely off state and an on state. In examples, the state transition pattern may include a completely off state, a common channel only state, and an on state. In examples, the assistance information (e.g., state transition pattern) may include information to determine a state of the cell.

The first absolute priority information may include a first absolute priority value associated with a first frequency and a second absolute priority value associated with a second frequency. Reselection may be performed using the first absolute priority information for the WTRU. The reselection using the first absolute priority information for the WTRU may be performed by determining that the second absolute priority value associated with the second frequency is greater than the first absolute priority value associated with the first frequency. Based on the determination that the second absolute priority value associated with the second frequency is greater than the first absolute priority value associated with the first frequency, the second frequency may be prioritized. Reselection may be performed to a cell associated with the second frequency. Uplink information may be transmitted to the cell. The cell may be a neighbor cell. The reselection to the neighbor cell may be a reselection from a serving cell to the neighbor cell. The neighbor cell may have NTN and DL-CE capabilities.

A WTRU may support non-terrestrial network (NTN) and downlink-coverage enhancements (DL-CE). The WTRU may acquire system information. The WTRU may check if there is absolute priority information associated with NTN and DL-CE capabilities in the acquired system information (e.g., either in an existing SIB or a new SIB). The WTRU may consider the NTN and DL-CE capabilities specific absolute priority values per frequency associated with the current serving cell and the neighboring cells. The WTRU may perform absolute priority reselection based on the absolute priority values (e.g., the WTRU may prioritize frequencies with higher absolute priority values over frequencies with lower absolute priority values). The WTRU may send an uplink message on the serving cell selected during the absolute priority reselection. The uplink message may be sent based on uplink user data or an uplink control message (e.g., an uplink non-access stratum (NAS) message) becoming available for transmission.

Examples associated with NTN downlink coverage enhancements are provided herein. If WTRUs not supporting DL-CE are barred, WTRUs not supporting DL-CE may be barred from accessing a cell operating with DL-CE using the existing NTN bar bit. If WTRUs not supporting DL-CE are barred, then a barring mechanism may be included to control the access of WTRUs supporting NTN DL-CE (e.g., thus WTRUs supporting NTN DL-CE may not consider the existing NTN barring bit). WTRUs not supporting DL-CE may be allowed to down-prioritize or prevent re-selection to cells operating with DL-CE.

In examples, NTNs may provide non-terrestrial NR access to the WTRU by means of an NTN payload and an NTN gateway, which may depict a service link between the NTN payload and the WTRU, and a feeder link between the NTN gateway the NTN payload. In examples, the NTN payload may be transparent. The transparent payload may transparently forward the radio protocol received from the WTRU to the NTN gateway and vice-versa. In examples, the NTN payload may be regenerative and may host a gNB. The regenerative payload may terminate the Uu interface and the NG interface.

The following connectivity may be supported by the NTN payload: an NTN gateway may serve multiple transparent or regenerative NTN payloads; a transparent or regenerative NTN payload may be served by multiple NTN gateways; a regenerative NTN payload may terminate one or more inter-satellite links toward other regenerative payloads; the feeder link may be a transport link; the feeder link may transport the NG interface between the 5GC and the gNB hosted by the regenerative payload; the inter-satellite link may a transport link; and the inter-satellite link may transport the Xn interface between the gNBs hosted by the two regenerative payloads. In examples, the transparent NTN-payload may change the carrier frequency (e.g., before re-transmitting the carrier frequency on the service link, and vice versa (e.g., respectively on the feeder link).

For NTN, the following may apply: a tracking area may correspond to a fixed geographical area (e.g., any respective mapping may be configured in the RAN); and mapped cell ID.

NTN may be deployed to provide coverage with an earth-moving cell, a quasi-earth-fixed cell, and earth-fixed cell, which may be supported respectively by the following three types of service link: earth-fixed, quasi-earth fixed, or earth-moving. For the earth-fixed service link, the service link may be provisioned by beam(s) continuously covering the same geographical areas all the time (e.g., the case of GSO satellites). For the quasi-earth-fixed service link, the service link may be provisioned by beam(s) covering one geographic area for a limited period and a different geographic area during another period (e.g., the case of NGSO satellites generating steerable beams). For the earth-moving service link, the service link may be provisioned by beam(s) whose coverage area slides over the earth surface (e.g., the case of NGSO satellites generating fixed or non-steerable beams). With NGSO satellites, the gNB may provide either a quasi-earth-fixed service link or an earth-moving service link, while the gNB operating with GSO satellite may provide an earth fixed service link or a quasi-earth-fixed service link. In examples, the WTRU supporting NTN may be GNSS-capable. In NTN, the distance may refer to a Euclidean distance.

DL-CE for NTN may provide at least one of the following: optimized performance when addressing handset terminals; optimized capacity performance on uplink through multiplexing techniques; a multicast and broadcast services (MBS) feature; support for NTN architecture with 5G system functions on board the NTN vehicle (e.g., regenerative payloads); or addressing the RedCap WTRU within NTN.

For the optimized performance when addressing handset terminals, DL-CE may provide optimized performance regarding downlink coverage when addressing handset terminals (e.g., including smartphones with −5.5 dBi antenna gain) considering the NTN deployment constraints such as payload power limitation, large satellite footprint, and limited feeder link bandwidth. DL coverage enhancements may accommodate satellite payload constraints which may be unable to have all its beams active with the nominal EIRP density per beam at a given time due to limited power and limited feeder link bandwidth. The DL-CE may maximize the number of beams that can be activated simultaneously and may ensure that all user terminals may be served across the satellite footprint while maximizing the overall satellite throughput and ensuring that all satellite's radio cells are kept alive (e.g., even without traffic). The DL-CE may allow new users to join and may prevent impact on end-user QoS. DL-CE may be considered at both the link level and the system level. For the link level, DL-CE may improve the link margin of selected physical channels to accommodate the EIRP reduction in NTN. A link margin improvement for physical channels (e.g., PDSCH and PDCCH) may be considered without impact on SSB design. For the service level, DL-CE may support an efficient dynamic and flexible power sharing between beams or different beam pattern/size (e.g., wide or narrow) across the satellite footprint for NTN.

For the optimized capacity performance on uplink through multiplexing techniques, DL-CE may offer optimized capacity performance on uplink through multiplexing techniques, which may be motivated by at least one of: the coverage of NTN satellites being very wide, and considering device density, a large number of WTRUs being within a satellite's coverage (e.g., especially for LEO, a large number of WTRUs in coverage may succeed in transmitting desired data during a satellite coverage which means that rapid access to and release of satellite resources may be required); the total spectrum resources available to the network being limited (e.g., especially in the early phases of NR NTN deployments); some users requiring higher resources than others, depending on their traffic patterns (e.g., therefore, further granularity of resource multiplexing may improve system capacity efficiency); allocating higher per-WTRU resources to better support VoNR/VoIP services in coverage-limited scenarios.

For the MBS feature, the DL-CE may provide MBS feature that includes an important add-value for NR NTN system, which may leverage the large coverage of the NTN compared to TN. Terrestrial MBS features may be equally available for NR NTN, but for some cases the intended service area may be expected to be smaller than the coverage of a Uu cell. Some enhancements may notify the service area of a broadcast service.

For support for NTN architecture with 5G system functions on board the NTN vehicle (e.g., regenerative payloads), the DL-CE may provide new architecture option(s) besides the transparent payload, which may make the deployment of non-terrestrial network more flexible. Support of a regenerative payload may bring benefits on radio resource handling in Uu, and radio resource coordination between the gNBs via the ISL. For the support of real time connectivity between two WTRUs and between network and WTRU via the space segment with/without ISL, a regenerative payload (e.g., 5G system functions on board satellite) may be required.

For addressing the RedCap WTRU within NTN, the support of RedCap devices (e.g., handheld and IoT) operating in NR-NTN networks may offer enhanced service capabilities (e.g., wideband/broadband) compared to IoT-NTN while ensuring low-complexity devices. Global coverage may benefit RedCap devices.

DL-CE for NTN may include at least one of the following: a geo synchronous orbit (GSO) and a non-geo synchronous orbit (NGSO) (e.g., NGSO may include low earth orbit (LEO) and medium earth orbit (MEO); an earth fixed tracking area (e.g., earth fixed and earth moving cells for NGSO); frequency division duplex (FDD) mode; WTRUs with global navigation satellite systems (GNSS) capabilities; in frequency bands above 10 GHz, both terminal type 1 (e.g., electronic steering antenna) and type 2 (e.g., mechanical steering antenna) to be considered for GSO and NGSO; or implicit compatibility to support high altitude platform station (HAPS) and air to ground (ATG) scenarios. In examples, a “VSAT” device with an external antenna on a moving platform may be equivalent to a device that operates on platforms in motion (e.g., referred to as earth station in motion (ESIM).

DL-CE may provide support for reference satellite payload parameters covering both GSO and NGSO constellations operating in FR1-NTN or FR2-NTN. Satellite payload parameters may include power sharing among satellite beams or different satellite beam patterns/size (e.g., wide or narrow) across the satellite footprint, such that satellite beams may not all be simultaneously active or may be active below the nominal EIRP density per satellite due to limited power and limited feeder link bandwidth. DL-CE may include power sharing assumptions a link level and system level evaluation methodology, and relevant KPIs for evaluations of the coverage. This may allow for identification of physical channels/signals and system-level aspects for corresponding enhancements and improvements. DL-CE may include link level enhancements for FR1-NTN (e.g., for PDCCH, PDSCH) and/or system level enhancements for FR1-NTN and/or FR2-NTN, which may allow dynamic and flexible power sharing between satellite beams or different satellite beam patterns/size (e.g., wide or narrow) across the satellite footprint. RAN1 may report the list of targeted physical channels/signals for link level enhancements (if any), and with the targeted system-level enhancements (if any). RAN may report on impact to backward compatibility, if any, for potential extension of the SSB periodicity at the latest by RAN, in conjunction with the targeted system-level enhancements.

SSB channel enhancement other than SSB periodicity extension may not be considered. RAN may consider a WTRU's cell search complexity and an impact to initial cell selection, latency, and success rate, for the above extension. The SSB periodicity enhancements may apply (e.g., may only apply) to NTN operation. Antenna gain of a WTRU may be −5.5 dBi in case of smartphone in FR1-NTN. The WTRU may be a full duplex WTRU. At least 2Rx may be considered at the WTRU. NGSO may be considered in priority: LEO Set-1 @ 600 km. Network energy saving techniques may be considered.

DL-CE may provide uplink capacity/cell throughput enhancement for FR1-NTN. DL-CE may specify orthogonal cover codes (OCC) for DFT-s-OFDM PUSCH at least for multiplexing 2 or 4 WTRUs when PUSCH repetitions are used. Necessary signaling may be specified. RF requirements may be updated.

DL-CE may specify signaling of the intended service area of a broadcast service (e.g., MBS broadcast) via NR NTN. SIB signaling to indicate the intended service area in case the satellite footprint covers a larger area may be specified. The signaling between CN and NG-RAN may be specified.

DL-CE may support regenerative payloads. Enhancements related to the intra and inter-gNB mobility, especially for Xn interface over feeder link or over ISL, may be supported.

DL-CE may support eRedCap WTRUs with NR NTN operating in FR1-NTN bands. For full-duplex and half duplex FDD RedCap and eRedCap WTRUs, DL-CE may define the radio frequency (RF) and radio resource management (RRM) requirements. For HD-FDD RedCap UEs and eRedCap WTRUs, DL-CE may specify enhancements for mitigating issues caused by timing advance (TA) mismatch between actual TA used by the WTRU and assumed TA for the WTRU at the gNB.

Enhancements may be targeted for the following HD collisions cases: a semi-statically configured DL reception colliding with a semi-statically configured UL transmission; and a dynamically scheduled DL reception colliding with a dynamically scheduled UL transmission. GNSS capabilities and simultaneous GNSS and NR-NTN operations may be supported in RedCap/eRedCap WTRU.

Examples of synchronization signal block (SSB) periodicity extension are provided herein. If the SSB periodicity is no larger than 160 ms, there may be no RAN impact on SSB configuration (e.g., there may still be impacts on DTX aspects). If the SSB periodicity is larger than 160 ms, ssb-PeriodicityServingCell, measurement gap periodicity, SMTC configuration, ssb-Periodicity-r17 for NonCellDefiningSSB-r17 may (e.g., may need to) be extended. The field description of nAndPagingFrameOffset may (e.g., may also need to) be enhanced to consider the SSB periodicity higher than 160 ms. RAN may (e.g., may further) consider how SS/PBCH block measurement timing configuration (SMTC) impacts due to beam-hopping/larger SSB periodicity. If NTN WTRUs are barred from accessing a cell operating with DL coverage enhancement (e.g., because of extreme SSB periodicity), the existing NTN bar bit may be used.

WTRUs not supporting NTN DL-CE may not be able to camp on a cell operating with NTN DL-CE if the SSB periodicity is set to any value greater than 160 ms (e.g., as non-DL-CE supporting WTRUs may not expect SSB periodicity to be set to a greater value than 160 ms). To avoid the WTRUs not supporting NTN DL-CE to attempt accessing the cell operating with NTN DL-CE, the existing NTN bar bit may be used to bar those WTRUs from accessing the cell. WTRUs cell-reselecting to the other cells with DL-CE may be avoided (e.g., as described herein).

An intra-frequency reselection information element (IFRI) may be used to prevent a WTRU from cell-reselecting to a cell on the same frequency as the barred cell. The IFRI may be used (e.g., may only be used) for WTRUs that can receive the updated IFRI. The IFRI may not work for legacy WTRUs, which may suffer from the battery drain imposed by the unsuccessful cell selections/reselections due to NTN CE operation.

In examples, there may be an absolute priority reselection function, which may enable the network to configure absolute priority per frequency so that WTRU can prioritize the higher priority frequencies over the lower priority frequencies. The absolute priority mechanism may be applied to the WTRUs (e.g., all the WTRUs) under the cell coverage. Slice-based cell reselection may enable the network to configure different priorities per slice associated with the WTRU under the cell coverage (e.g., a different absolute priority may be configured per service). If the WTRUs do not support NTN DL-CE, absolute priority mechanisms may de-prioritize the frequencies where cells operating with DL-CE are deployed (e.g., there may be no mechanism for WTRU-capability based cell reselection). Examples of means for a WTRU to down-prioritize frequencies based on a specific WTRU capability are provided herein.

Examples associated with absolute priority reselection based on DL-CE capability are provided herein. The network may provide absolute priority information associated with the frequency of a serving cell and frequencies of neighbor cell(s) for specific WTRU-capabilities (e.g., NTN and DL-CE capabilities).

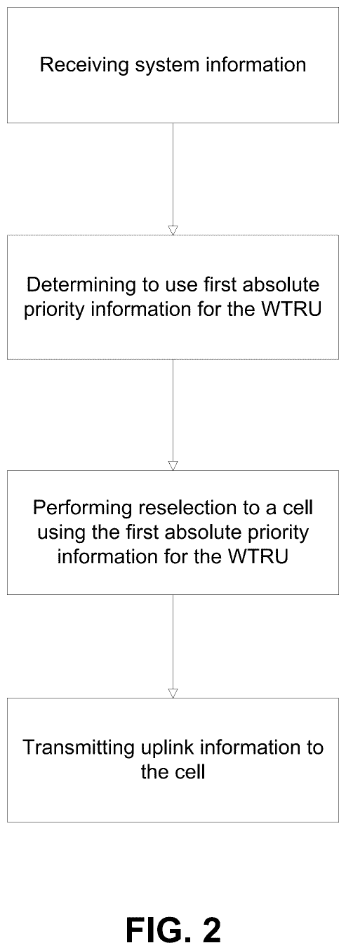

FIG. 2 illustrates an example of downlink-coverage enhancements (DL-CE) capabilities-based cell selection or cell reselection. A WTRU may acquire (e.g., receive) system information. The WTRU may be associated with (e.g., may support) NTN and DL-CE capabilities. The WTRU may check if there is any absolute priority information associated with NTN and DL-CE capable WTRUs in the acquired (e.g., received) system information. The system information may be acquired (e.g., received) in an existing SIB or a new SIB (e.g., defined for this purpose). For example, the system information may include first priority information associated with non-terrestrial network (NTN) and downlink-coverage enhancements (DL-CE) capabilities, and second priority information not associated with NTN and DL-CE capabilities. The WTRU may determine to use the first absolute priority information based on the first absolute priority information being associated with the NTN and DL-CE capabilities. The WTRU may determine to use the first absolute priority information based on the first absolute priority information being associated with the NTN and DL-CE capabilities and based on the second absolute priority information not being associated with the NTN and DL-CE capabilities.

The system information may include (e.g., may further include) assistance information associated with a cell. In examples, the WTRU may acquire (e.g., receive) system information and check if there is any assistance information associated with the neighboring cells operating with NTN and DL-CE capabilities in the acquired (e.g., received) system information (e.g., received in the existing SIB or a new SIB). In examples, the WTRU may determine to use the first absolute priority information for the WTRU based on (e.g., further based on) the assistance information. The assistance information may include at least one of: a state transition pattern associated with a cell (e.g., associated with a neighbor cell with NTN and DL-CE capabilities); a synchronization signal block (SSB) periodicity associated with a cell (e.g., associated with a neighbor cell with NTN and DL-CE capabilities); or a duty cycle associated with the state transition pattern (e.g., the state transition pattern (e.g., ON/OFF periods) of the neighbor cell with NTN and DL-CE capabilities). In examples, the state transition pattern may include a completely off and an ON state. In examples, the state transition pattern may include a completely off, a common channel only, and an ON state. The state transition pattern may determine a state of the cell (e.g., may notify the WTRU when/how the corresponding cell changes the state).

The WTRU may perform reselection (e.g., absolute priority reselection) using absolute priority information associated with NTN and DL-CE capabilities. The absolute priority information may include specific absolute priority values per frequency associated with (e.g., associated with each of) the current serving cell and the neighbor cell(s). The WTRU may prioritize the frequencies with higher absolute priority value over frequencies with lower absolute priority values. In examples, the first absolute priority information (e.g., associated with non-terrestrial network (NTN) and downlink-coverage enhancements (DL-CE) capabilities) may include a first absolute priority value associated with a first frequency and a second absolute priority value associated with a second frequency. Reselection using the first absolute priority information for the WTRU may be performed by determining that the second absolute priority value associated with the second frequency is greater than the first absolute priority value associated with the first frequency. Based on the determination that the second absolute priority value associated with the second frequency is greater than the first absolute priority value associated with the first frequency, the second frequency may be prioritized. The WTRU may reselect to a cell associated with the second frequency.

In examples, the cell may be a neighbor cell. The reselection to the neighbor cell may be a reselection from a serving cell to the neighbor cell. The neighbor cell may have NTN and DL-CE capabilities. The WTRU may (e.g., may further) consider the assistance information of the neighbor cell and may (e.g., may further) determine the absolute priority of the neighbor cell frequency based on the assistance information. The WTRU may consider the DL-CE state or DL-CE state transition pattern of the neighbor cell. The WTRU may determine the absolute priority of the neighbor cell frequency based on at least one of: the DL-CE state of the neighbor cell (e.g., if the cell is in a period of completely off, then the frequency may be deprioritized, if the cell is in a period of ON, then the frequency may be prioritized over the other frequencies, if the cell is in a period of completely off, then the first absolute priority information may not be used for absolute priority reselection, or if the cell is in a period of ON, then the first absolute priority information may be used for absolute priority reselection); the SSB periodicity of the neighbor cell; or the duty cycle associated with the DL-CE states or DL-CE state transitions (e.g., ON/OFF periods) of the neighbor cell.

The WTRU may determine that uplink user data or an uplink control message (e.g., uplink NAS message) becomes available for transmission. The WTRU may transmit uplink information to the cell selected during the absolute priority reselection based on the determination that the uplink user data or uplink control message (e.g., uplink NAS message) becomes available for transmission.

In examples, the network may set lower absolute priority values for the DL-CE operating frequencies by using existing signaling (e.g., SIB4, SIB5 and SIB16). The existing signaling may allow the legacy WTRUs (e.g., WTRUs not supporting NTN and DL-CE) to follow the absolute priority information given by the legacy signaling while allowing WTRUs supporting DL-CE to follow the new absolute priority information, which may prioritize the DL-CE operating frequencies.

Examples of DL-CE capability based absolute priority reselection are provided herein. A network may provide absolute priority information for the frequency of a serving cell and for frequencies of neighbor cells for NTN DL-CE capable WTRUs.

A WTRU supporting NTN and DL-CE capabilities may acquire system information. The WTRU may check if there is any absolute priority information defined for NTN DL-CE capable WTRUs in the acquired system information (e.g., either in an existing SIB or a new SIB (e.g., defined for this purpose). The WTRU may consider NTN DL-CE capable specific absolute priority values per frequency associated with the current serving cell and the neighboring cells. The WTRU may perform absolute priority reselection based on the absolute priority values (e.g., the WTRU may prioritize the frequencies with higher absolute priority values over frequencies with lower absolute priority values). The WTRU may transmit an uplink message on the serving cell selected during the absolute priority reselection. The uplink message may be transmitted based on uplink user data or an uplink control message (e.g., an uplink NAS message) becoming available for transmission.

Examples of DL-CE state based absolute priority reselection are provided herein. The network may provide absolute priority information for the frequency of a serving cell and for frequencies of neighbor cells for NTN DL-CE capable WTRUs. The network may provide (e.g., may also provide) assistance information associated with the DL-CE state pattern.

A WTRU supporting NTN and DL-CE capabilities may acquire system information. The WTRU may check if there is any absolute priority information defined for NTN DL-CE capable WTRUs in the acquired system information (e.g., either in an existing SIB or a new SIB defined for this purpose).

The WTRU may acquire system information and may check if there is any assistance information of the neighboring cells operating in NTN DL-CE in the acquired system information (e.g., either in an existing SIB or a new SIB). The assistance information may include one or more state transition patterns associated with one or more neighbor cells operating with DL-CE. The state transition pattern may be: an off state and an on state; or a completely off state, a common channel only state, or an on state. The state transition pattern may notify the WTRU when/how the corresponding cell changes the state (e.g., duty cycle of the states).

The WTRU may consider NTN DL-CE capable specific absolute priority values per frequency associated with the current serving cell and the neighboring cells. The WTRU may perform absolute priority reselection based on the absolute priority values (e.g., the WTRU may prioritize the frequencies with higher absolute priority values over frequencies with lower absolute priority values). The WTRU may (e.g., may further) consider the DL-CE state or the DL-CE state transition pattern associated with the neighboring cells. The WTRU may (e.g., may further) determine the absolute priority of the frequencies of the neighboring cells based on the DL-CE state. The WTRU may transmit an uplink message on the serving cell selected during the absolute priority reselection. The uplink message may be transmitted based on uplink user data or an uplink control message (e.g., uplink NAS message) becoming available for transmission.

A cell (e.g., an NTN cell) operating with DL-CE may have a state. The state may be a 2-state model or a 3-state model. The 2-state model may include an ON state and an OFF state. For the 2-state model, the cell may transmit common control channel signals and user data channels in the ON state while the cell may stop any transmission in the OFF state. The 3-state model may include an ON state, a common channel only state, and an OFF state. For the 3-state model, the cell may transmit: common control channel signals and user data channels in the ON state, the cell may transmit common control channel signals (e.g., SSB) in the common channel only state (e.g., only in the common channel only state), and the cell may stop any transmission in the OFF state.

DL-CE state based absolute priority handling may include at least one of: DL-CE state-based priority handling, SSB periodicity-based priority handling, or DL-CE duty cycle-based priority handling.

For DL-CE state-based priority handling (e.g., when considering the NTN DL-CE capable specific priority values per frequency and performing the absolute priority reselection with the priority values), the WTRU may apply the DL-CE capability specific absolute priority if the DL-CE state of the candidate neighboring cell is in ON state for the 2-state model or if the DL-CE state of candidate neighboring cell is in either the ON state or in the common channel only state for the 3-state model. The DL-CE state of the candidate neighboring cell may be predicted based on the assistance information of the DL-CE neighboring cell, which may provide a DL-CE state transition pattern (e.g., a duty cycle of the states).

For SSB periodicity-based priority handling (e.g., when considering the NTN DL-CE capable specific priority values per frequency and performing the absolute priority reselection with the priority values), the WTRU may apply the DL-CE capability specific absolute priority depending on the SSB periodicity of the candidate neighboring cell. If the SSB periodicity of the candidate neighboring cell is greater than a certain threshold (e.g., 160 ms), then the WTRU may apply the DL-CE capability specific absolute priority. If the SSB periodicity is less than or equal to a certain threshold (e.g., 160 ms), then the WTRU may apply the absolute priority information given by legacy signaling (e.g., SIB4, SIB5 and SIB16).

For DL-CE duty cycle-based priority handling (e.g., when considering the NTN DL-CE capable specific priority values per frequency and performing the absolute priority reselection with the priority values), the WTRU may apply the DL-CE capable specific absolute priority depending on the DL-CE state transition duty cycle of the candidate neighboring cell. If the DL-CE duty cycle of the candidate neighboring cell is greater than a certain threshold, then the WTRU may apply the DL-CE capability specific absolute priority. If the duty cycle is less than or equal to a certain threshold, then the WTRU may apply the absolute priority information given by legacy signaling (e.g., SIB4, SIB5 and SIB16).

Examples of DL-CE specific offset/adjustments reselection are provided herein. Examples of DL-CE capability specific parameters are provided herein. In examples, absolute priority may be replaced with an offset or adjustment.

A WTRU supporting NTN and DL-CE capabilities may acquire system information. The WTRU may check if there is any offset/adjustment information defined for NTN DL-CE capable WTRUs in the acquired system information (e.g., either in an existing SIB or a new SIB defined for this purpose).

The WTRU may acquire system information and may check if there is any assistance information of the neighboring cells operating in NTN DL-CE in the acquired system information (e.g., either in an existing SIB or a new SIB). The assistance information may include a state transition pattern associated with a DL-CE cell. The state transition pattern may be: a completely off state or an on state; or a completely off state, a common channel only state, or an on state. The state transition pattern may notify the WTRU when/how the corresponding cell changes the state (e.g., duty cycle of the states).

The WTRU may consider NTN DL-CE capable specific offset/adjustment per frequency/per cell associated with the neighboring cells. The WTRU may perform cell reselection with the given offset/adjustment (e.g., the WTRU may evaluate the candidate neighboring cells operating with DL-CE by applying the offset/adjustment to the measured radio signal strength/quality (e.g., RSRP, RSRQ)). The WTRU may consider the DL-CE state or the DL-CE state transition pattern associated with the neighboring cells. The WTRU may determine the applicability of the DL-CE capability specific offset/adjustment for the neighboring cells operating with DL-CE based on the DL-CE state. The WTRU may transmit an uplink message on the serving cell selected during the absolute priority reselection. The uplink message may be transmitted based on uplink user data or an uplink control message (e.g., uplink NAS message) becoming available for transmission.

The DL-CE capability specific offset/adjustment may be provided per frequency or per cell.

For the DL-CE capability specific offset/adjustment provided per frequency, the WTRU may receive the offset/adjustment per frequency. If the offset/adjustment is applied for the cell operating with DL-CE, the offset/adjustment may be applied for cells (e.g., all the cells) on the associated frequency.

For the DL-CE capable specific offset/adjustment provided per cell, the WTRU may receive the offset/adjustment per cell. If the offset/adjustment is applied for the cell operating with DL-CE, the offset/adjustment may be applied for the corresponding cell operating with DL-CE.

A cell operating with DL-CE may have a state. The state may be a 2-state model or a 3-state model. The 2-state model may include an ON state and an OFF state. For the 2-state model, the cell may transmit common control channel signals and user data channels in the ON state while the cell may stop any transmission in the OFF state. The 3-state model may include an ON state, a common channel only state, and an OFF state. For the 3-state model, the cell may transmit common control channel signals and user data channels in the ON state, the cell may transmit common control channel signals (e.g., SSB) in the common channel only state (e.g., only in the common channel only state), and the cell may stop any transmission in the OFF state.

DL-CE state based offset/adjustment handling at least one of: DL-CE state-based offset/adjustment handling, SSB periodicity-based offset/adjustment handling, or DL-CE duty cycle-based offset/adjustment handling.

For DL-CE state-based offset/adjustment handling (e.g., when considering the NTN DL-CE capable specific priority values per frequency and performing the absolute priority reselection with the priority values), the WTRU may apply the DL-CE capable specific offset/adjustment if the DL-CE state of the candidate neighboring cell is in the ON state for the 2-state model or if the DL-CE state of the candidate neighboring cell is in the ON state or the common channel only state for the 3-state model. The DL-CE state of the candidate neighboring cell may be predicted based on the assistance information of the DL-CE neighboring cell, which may provide a DL-CE state transition pattern (e.g., a duty cycle of the states).

For SSB periodicity-based offset/adjustment handling (e.g., when considering the NTN DL-CE capable specific priority values per frequency and performing the absolute priority reselection with the priority values), the WTRU may apply the DL-CE capable specific offset/adjustment depending on the SSB periodicity of the candidate neighboring cell. If the SSB periodicity of the candidate neighboring cell is greater than a certain threshold (e.g., 160 ms), then the WTRU may apply the DL-CE capability specific offset/adjustment. If the SSB periodicity is less than or equal to a certain threshold (e.g., 160 ms), then the WTRU may perform cell reselection as legacy (e.g., without considering the DL-CE capability specific offset/adjustment).

For DL-CE duty cycle-based offset/adjustment handling (e.g., when considering the NTN DL-CE capable specific priority values per frequency and performing the absolute priority reselection with the priority values), the WTRU may apply the DL-CE capability specific offset/adjustment depending on the DL-CE state transition duty cycle of the candidate neighboring cell. If the DL-CE duty cycle of the candidate neighboring cell is greater than a certain threshold, then the WTRU may apply the DL-CE capability offset/adjustment. If the duty cycle is less than or equal to a certain threshold, then the WTRU may perform cell reselection as legacy (e.g., without considering the DL-CE capability specific offset/adjustment).

An example of DL-CE specific absolute priority signaling for the introduction of an SIB case is provided in the table below.

SIBXX-r19 ::= SEQUENCE {

| | | |
|---|---|---|
| freqPriorityListDL-CE-r19 | FreqPriorityListDL-CE-r19 | OPTIONAL, -- Need R |
| lateNonCriticalExtension | OCTET STRING | OPTIONAL, |

...
}
FreqPriorityListDL-CE-r19 ::= SEQUENCE (SIZE (1..maxFreqPlus1)) OF FreqPriorityDL-CE-r19
FreqPriorityDL-CE-r19 ::= SEQUENCE {

| | |
|---|---|
| dl-ImplicitCarrierFreq-r19 | INTEGER (0..maxFreq), |
| cellReselectionPriority-r19 | CellReselectionPriority, |
| cellReselectionSubPriority-r19 | CellReselectionSubPriority OPTIONAL, -- Need R |

}
FreqPriorityListDL-CE field descriptions
dl-ImplicitCarrierFreq
May indicate the downlink carrier frequency to which the given absolute priority is associated with.
The frequency may be signaled implicitly, value 0 may correspond to the serving frequency, value 1
may correspond to the first frequency indicated by the InterFreqCarrierFreqList in SIB4, and value 2
may correspond to the second frequency indicated by the InterFreqCarrierFreqList in SIB4, and so on.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

What is claimed:

1. A wireless transmit/receive unit (WTRU), comprising:
a processor configured to:
receive system information, wherein the system information includes at least: first absolute priority information associated with non-terrestrial network (NTN) and downlink-coverage enhancements (DL-CE) capabilities, and second absolute priority information not associated with NTN and DL-CE capabilities;
determine to use the first absolute priority information for the WTRU based on at least the first absolute priority information being associated with the NTN and DL-CE capabilities, wherein the first absolute priority information includes a first absolute priority value associated with a first frequency and a second absolute priority value associated with a second frequency;
perform a reselection using the first absolute priority information for the WTRU, wherein the performance of the reselection using the first absolute priority information for the WTRU comprises the processor being further configured to:
determine that the second absolute priority value associated with the second frequency is greater than the first absolute priority value associated with the first frequency,
based on the determination that the second absolute priority value associated with the second frequency is greater than the first absolute priority value associated with the first frequency, prioritize the second frequency, and
based on the second frequency being prioritized, reselect to a cell associated with the second frequency; and
transmit uplink information to the cell.

2. The WTRU of claim 1, wherein the cell is a neighbor cell, and wherein the reselection to the neighbor cell is a reselection from a serving cell to the neighbor cell.

3. The WTRU of claim 2, wherein the neighbor cell has NTN and DL-CE capabilities.

4. The WTRU of claim 1, wherein the system information further includes assistance information associated with the cell.

5. The WTRU of claim 4, wherein the determination to use the first absolute priority information for the WTRU is further based on the assistance information.

6. The WTRU of claim 5, wherein the assistance information includes at least one of: a state transition pattern, a synchronization signal block (SSB) periodicity, or a duty cycle associated with the state transition pattern.

7. The WTRU of claim 6, wherein the state transition pattern comprises:
a completely off state and an on state; or
a completely off state, a common channel only state, and an on state.

8. The WTRU of claim 6, wherein the assistance information comprises information to determine a state of the cell.

9. The WTRU of claim 1, wherein the processor is further configured to:
determine that uplink user data or an uplink control message is available for transmission, wherein the uplink information is transmitted to the cell based on the determination that the uplink user data or the uplink control message is available for transmission.

10. The WTRU of claim 1, wherein the WTRU supports NTN and DL-CE capabilities.

11. A method associated with a wireless transmit/receive unit (WTRU), the method comprising:
receiving system information, wherein the system information includes at least: first absolute priority information associated with non-terrestrial network (NTN) and downlink-coverage enhancements (DL-CE) capabilities, and second absolute priority information not associated with NTN and DL-CE capabilities;
determining to use the first absolute priority information for the WTRU based on at least the first absolute priority information being associated with the NTN and DL-CE capabilities, wherein the first absolute priority information includes a first absolute priority value associated with a first frequency and a second absolute priority value associated with a second frequency;
performing a reselection using the first absolute priority information for the WTRU, wherein the performance of the reselection using the first absolute priority information for the WTRU further comprises:
determining that the second absolute priority value associated with the second frequency is greater than the first absolute priority value associated with the first frequency,
based on the determination that the second absolute priority value associated with the second frequency is greater than the first absolute priority value associated with the first frequency, prioritizing the second frequency, and
based on prioritizing the second frequency, reselecting to a cell associated with the second frequency; and
transmitting uplink information to the cell.

12. The method of claim 11, wherein the cell is a neighbor cell, and wherein the reselection to the neighbor cell is a reselection from a serving cell to the neighbor cell.

13. The method of claim 12, wherein the neighbor cell has NTN and DL-CE capabilities.

14. The method of claim 11, wherein the system information further includes assistance information associated with the cell.

15. The method of claim 14, wherein the determination to use the first absolute priority information for the WTRU is further based on the assistance information.

16. The method of claim 15, wherein the assistance information includes at least one of: a state transition pattern, a synchronization signal block (SSB) periodicity, or a duty cycle associated with the state transition pattern.

17. The method of claim 16, wherein the state transition pattern comprises:
a completely off state and an on state; or
a completely off state, a common channel only state, and an on state.

18. The method of claim 16, wherein the assistance information comprises information to determine a state of the cell.

19. The method of claim 11, further comprising:
determining that uplink user data or an uplink control message is available for transmission, wherein the uplink information is transmitted to the cell based on the determination that the uplink user data or the uplink control message is available for transmission.

20. The method of claim 11, wherein the WTRU supports NTN and DL-CE capabilities.
